(19) United States
(12) Patent Application Publication
(10) Pub. No.: US 2023/0405449 A1
(43) Pub. Date: Dec. 21, 2023

(54) GRAPH-BASED WORD PUZZLE

(71) Applicant: Michael L Carroll, Allen, TX (US)

(72) Inventor: Michael L Carroll, Allen, TX (US)

(21) Appl. No.: 18/200,937

(22) Filed: May 23, 2023

Related U.S. Application Data
(60) Provisional application No. 63/345,601, filed on May 25, 2022.

(51) Int. Cl. A63F 9/00; A63F 13/822

(52) U.S. Cl. CPC A63F 9/0098; A63F 13/822

(57) ABSTRACT

A puzzle with letter placeholders coupled with a plurality of arrow indicia. The arrow indicia may be disposed to associate at least a first letter of the letter indicia with a second letter, thus associating the first letter and the second letter to form a portion of, or a complete word spelled with the first and second letter. Further disclosed is a method to make a puzzle including identifying a first word in a language, said word including a plurality of letters; identifying one or more subwords of the first word; associating the letters of the first word and subwords, said associating including the ordering of letters in the first word and subwords, and presenting an image of the puzzle, with a placeholder for each letter in the first word and a connecting links representative of the order of letters in the first word.

### PRIORITY

This application claims the benefit of co-pending U.S. provisional patent application 63/345,601 filed May 25, 2022, by the same inventor which is include herein in its entirety, together with its appendix, as if fully set forth herein.

### BACKGROUND

The following disclosure requires a basic knowledge of the mathematical theory known as graph theory, including the concepts of directed graph, nodes or vertices, edges or arcs, connectedness, graph traversal (such as paths, walks, and trails); in-degree, out-degree, and subgraph.

### SUMMARY

Disclosed herein are a system and methods for generating a word game puzzle called Wordwalk. The wordwalk puzzle consists of a directed graph generated from a single word (of any language) called the root word and some of its subwords; a subword may be any word in the same language whose set of letters is a subset of the letters of the original root word. Each letter of the root word and subwords is assigned to one and only one node of the graph. Arrows in the graph indicate the relationship of one letter following another in either the root word or in the given subwords. The set of letters needed to spell out the root word and its subwords may be provided in random order for the player to choose from and assign the letters to the nodes of the graph. A Wordwalk game is played by challenging the player to correctly guess the root word from an incomplete graph and the subwords. This may be done by correctly assigning letters from the subwords to the various blank nodes of the graph in such a way that the arrows of the graph point from each letter to the next one as it appears in the word(s). Spelling out a word that is neither the root word nor one of the subwords may not be allowed in certain embodiments. In some embodiments, the subwords are given in a separate list while the root word has to be guessed. All of the arrows needed for the complete graph are given initially, but all the nodes are initially blank, except that in some embodiments, one or more of the root word's letters may be shown.

In a representative embodiment a puzzle is disclosed. The puzzle may include a plurality of letter indicia coupled with a plurality of arrow indicia. The arrow indicia may be disposed to associate at least a first letter of the letter indicia with a second letter, thus associating the first letter and the second letter to form a portion of, or a complete word spelled with the first and second letter.

Further disclosed is a method to make a puzzle including identifying a first word in a language, said word including a plurality of letters; identifying one or more subwords of the first word; associating the letters of the first word and subwords, said associating including the ordering of letters in the first word and subwords, and presenting an image of the puzzle, with a placeholder for each letter in the first word and a connecting links representative of the order of letters in the first word.

The image may have at least one placeholder with a letter included. And the image may display placeholders and connecting indicia for subwords as well.

In some embodiments a system to generate the wordwalk puzzle may consist of hardware and software components. The methods of this system are incorporated in algorithms of the software used for generating the wordwalk puzzles; these algorithms are described in detail herein. The generated puzzles may be printed out and solved offline with pencil and paper or solved via a graphical user interface.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates an unsolved wordwalk puzzle for the word ‘birthday’.

FIG. 2 illustrates a solved wordwalk puzzle for the word ‘birthday’.

FIG. 3 illustrates a high-level workflow for wordwalk puzzle design and rendering.

FIG. 4 illustrates a mid-level flowchart of wordwalk puzzle design algorithms.

FIG. 5 presents a detailed flowchart of the core function “convert root word and subwords to graph representation.”

FIG. 6 shows how the root word ‘birthday’ and its subwords ‘day’, ‘had’, ‘hard’, and ‘hat’ are iteratively transformed via the algorithm of FIG. 5 into the final dictionary representation of a single wordwalk graph.

FIG. 7 presents a graphiz.dot representation after transformation of the internal key/value representation.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm. Prototype versions of the invention described herein have been built in both a declarative language (Prolog) and an imperative language (Python).

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The word “stack” or “logical stack” generally refers to a set of software subsystems or components needed to deliver a fully functional solution, e.g. a product or service. Often a stack may include an operating system, a server, a data management system and a scripting or other form of programming language. Stacks may be configured in a variety of ways depending on the desired function of the system. Stacks may be collections of elements, or they may be represented by pointers (or links) to the elements themselves.

The term “virtual machine” or “VM” generally refers to a self-contained operating environment that behaves as if it is a separate computer even though is is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Objectives

One or more of the objectives of the current disclosure may be recognized as:
A novel word game that uses directed graphs as the structuring principle for the play of the game.
An object of the game to correctly fill in all the blank nodes and to discover the root word from which the Wordwalk graph was generated.
Disclosure of the following rule for playing the game: The assignment of letters to nodes in the Wordwalk graph must be consistent with each of the revealed subwords.
Play of the game may be presented and controlled by a smartphone app, the play of the game may also be timed and integrated with a reward system.
An internet-based web server that presents a unique game each day and records how long it takes registered users to solve the puzzle, presenting recognition and rewards for the fastest puzzle solvers.
A logic program, which may be implemented in Prolog, that generates Wordwalk puzzles of varying difficulties from a given list of words.
A Python (or equivalent) program representing the Wordwalk graphs in key/value dictionary form and for transforming such graphs into graphviz.DOT files or other suitable file format.
Semantic variants of the Wordwalk puzzle in which hints are given in terms of definitions, synonyms, antonyms and homonyms (similar to how the clues for crossword puzzles are presented).

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories, and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device. Moreover, processor instructions may be encoded on one or more non-transitory memory devices.

### Client Server Processing

A client server system may be employed for some embodiments according to the current disclosure. the server may be coupled to one or more databases and to a network. The network may include routers, hubs and other equipment to effectuate communications between all associated devices. A user accesses the server by a computer communicably coupled to the network. The computer may include a sound capture device such as a microphone. Alternatively, the user may access the server through the network by using a smart device such as a telephone or PDA. The smart device may connect to the server through an access point coupled to the network. The mobile device includes a sound capture device such as a microphone.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions are conventionally known including applets and are written in a variety of languages including Java and JavaScript.

Client-server applications also provide for software as a service (SaaS) application where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

### Puzzle Construction

Wordwalk puzzles may be constructed by a computer program by first reading in a text file containing a list of words in the chosen language. The user of the software (the puzzle designer) may specify a root word either directly from the list or may allow the software to select one or more at random that conform to the puzzle designer's specification such as in terms of the number of letters in the root word, the number of subwords to be included, and the visibility of each subword. The puzzle generation software then finds words in the list that are subwords of the root word. From this list, the subword list, the user of the puzzle generation software may specify the minimum number of letters allowed for each subword and may also specify the total number of required subwords that will be revealed to the person who will attempt to solve the puzzle. The greater the number of required root words and subwords included the greater the complexity of the generated graph. The complexity of a graph is a function of its order (the number of nodes, as determined by all the root words) and its size (the number of its edge arrows, as determined jointly by the root words and the subwords). This complexity metric allows the puzzle designer to control the level of difficulty in solving the puzzle (i.e., in determining the root word(s)).

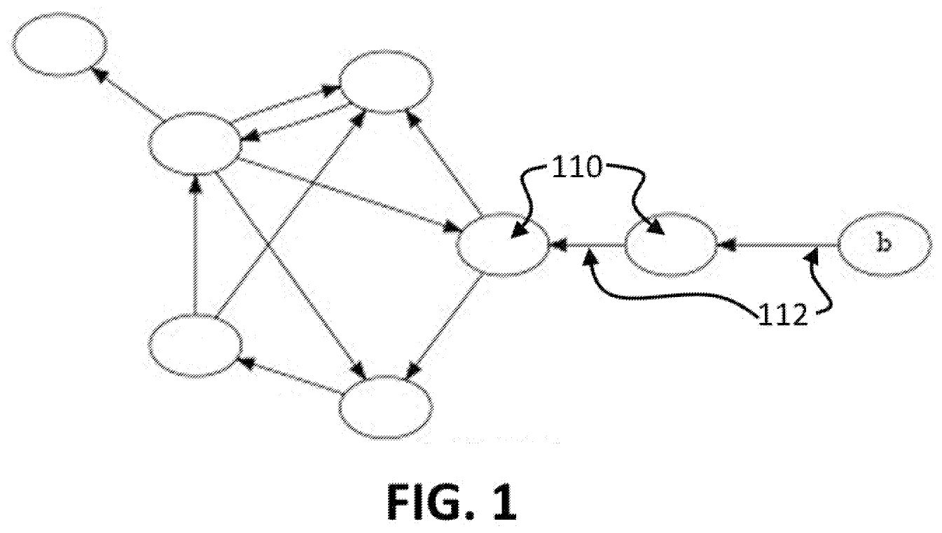

FIG. 1 illustrates an unsolved “WordWalk” Puzzle for the word ‘birthday’. It is formed by representing the word symbolically in the computer as a key/value dictionary: {b:{i},l:{r}, r:{t}, t{h}, h:{d}, d:{a}, a:{y} }. The puzzle includes indicia representing letters 110, and indicia representing relationships between letters shown as arrows 112. Each of these elements represents an arrow or other relationship indicia: E.g., b:{i} indicates that an arrow is drawn from b's node to i's node. When this graph is initially shown to the user, however, only the assignment of the first letter to its node is shown. That is, all the arrows and nodes are shown but only the b node is labeled with the letter ‘b’. Placeholders for letters are shown as oval, however, other indicia may be employed in different embodiments. For example, and without limitation, underlines, boxes and the like may be used to show placement of letters.

To make the puzzle easier, the user of the puzzle generation software may reveal some of the letters contained in the root word. A sample puzzle, as generated by this software component, is shown in FIG. 1. This puzzle was generated from the root word “birthday” with the stipulation that the subwords may be at least 3 letters long and the number of subwords chosen is 4. The subwords may be chosen at random, as in this example, or specified by the user of the puzzle designer.

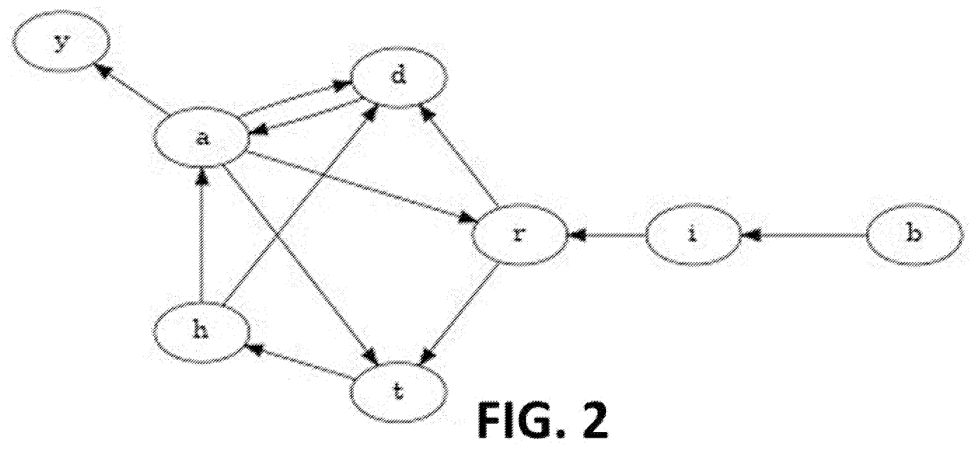

FIG. 2 illustrates a solved wordwalk puzzle for the word ‘birthday’. After the puzzle is correctly solved, all of the letters from ‘birthday’ are placed in the appropriate nodes. By starting at the node for letter ‘b’, the graph can walked by following the arrows all the way to the letter ‘y’. Two of the subwords that make up subgraphs for this particular graph are ‘day’ and ‘hard’, which, of course, can also be traced out as subgraphs of the full ‘birthday’ graph. To provide hints for solving the puzzle, some number of these embedded subwords will be given to the puzzle solver. In this example, the Note that not all possible subwords are used to generate the graph.

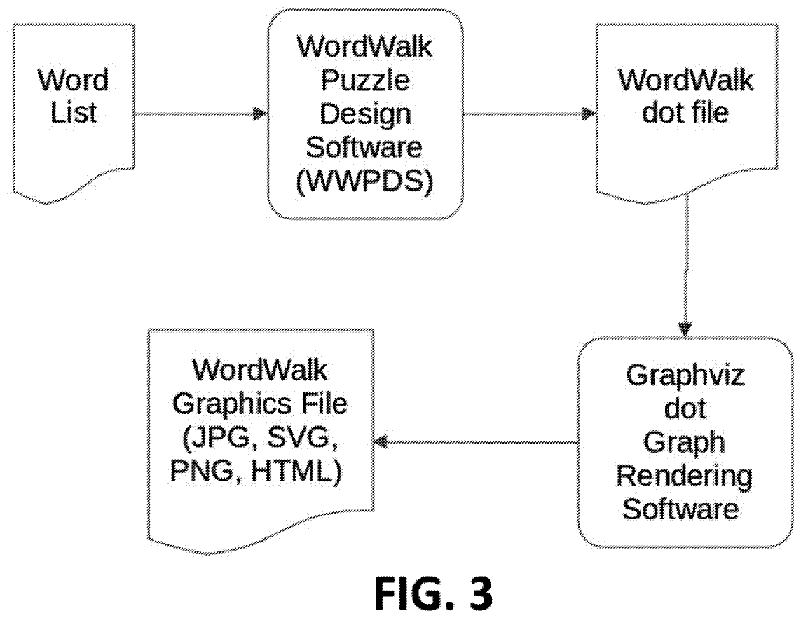

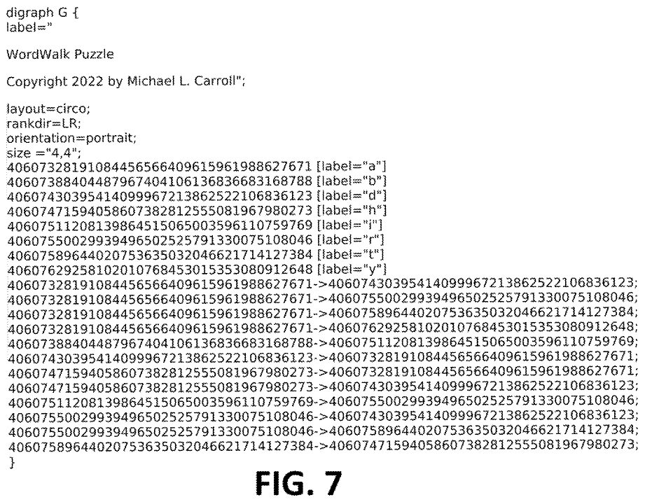

FIG. 3 illustrates a High-Level Workflow for WordWalk Puzzle Design and Rendering. (Rendering as a graphics file for visualization may be accomplished by an open-source program such as graphviz.) FIG. 3 also shows an overview of the process wherein a word list of possible solutions is submitted to a puzzle design software (or engine) that creates the output file containing the structure of the puzzle in a format for later processing. An example of a Wordwalk .DOT file is provided in FIG. 7. In this file the puzzle information is formatted as a textual description of a graph in the DOT language of graphviz which is a conventional package of open-source tools for drawing graphs specified in DOT language scripts. The software engine Graphviz DOT converts the puzzle data into a graphic for storing as a wordwalk graphics file. The transformation may result in Postscript, PDF, .JPG, .GIF, .PNG, .SVG, or HTML format. Interactive HTML format is the basis of a typical, online interactive version of the wordwalk puzzle to be played.

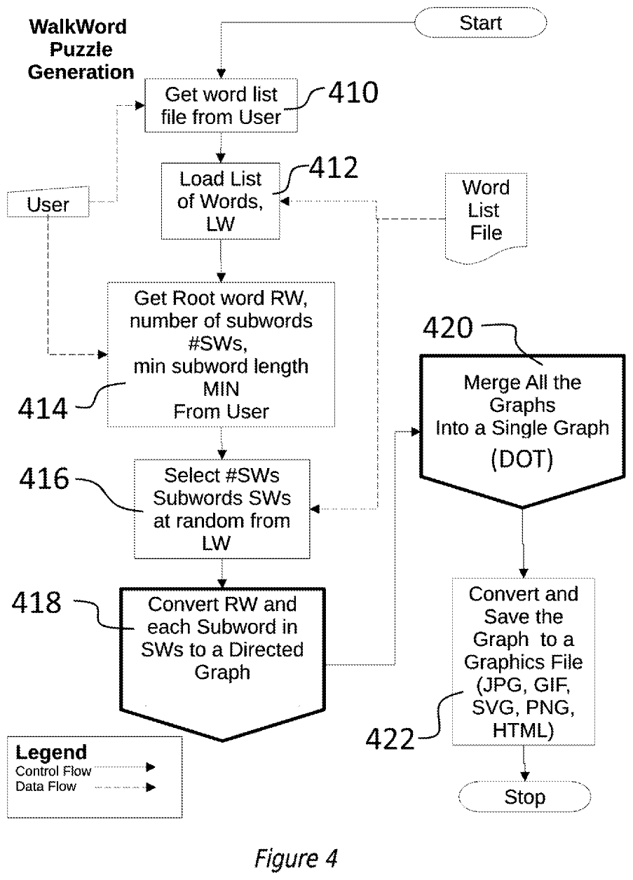

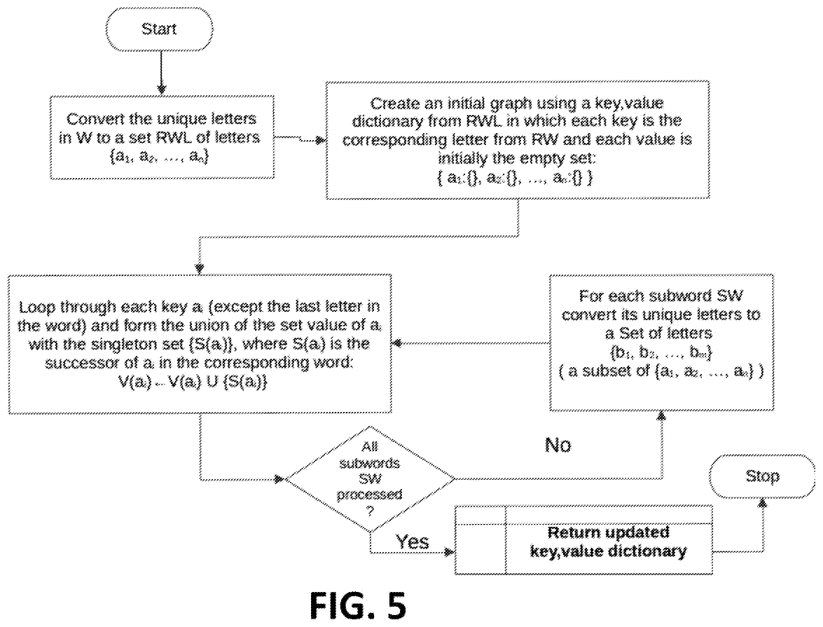

In FIG. 4, the process flow for specifying (designing) and producing a single Wordwalk puzzle is depicted. The first step 410 is providing the program with the filename of a master word list from which the root word(s) and subwords will be drawn. This file is read into memory in the second step 412 as a list of words (LW). Then the user specifies in the third step 414 the root word (RW), the number of subwords to include (#SWs), and the minimum length (MIN) of each included subword. Based on these parameters, #SWs subwords are chosen at random (alternatively, but not shown in the flowchart, the user may manual specify each of the subwords to be used) from the master list LW 416. This step also verifies that each subword selected is indeed a subword, i.e., each letter of a candidate subword must also occur in one or more of the root word. The fifth step 418 is where the root word(s) and all the subwords are converted to a single directed graph represented as a key/value dictionary object. Some details of the fifth step are shown in FIG. 5. Step 6 is to merge all the graphs into a single graph 420 converting the key/value dictionary object to a graphviz .DOT formatted file. A sample of this file format is shown in FIG. 7. Also included in this last step is the processing of the .DOT file format by the graphviz dot command, resulting in one of several standard graphics file formats 422.

In FIG. 5, the key process and method are shown for converting root words and subwords into internal key/value paired dictionary objects. A key/value pair dictionary is a data structure consisting of pairs of data items called key/value pairs. The keys are used to reference and obtain the associated value. These objects are also known as associative arrays in computer language. (In the Python language they may be referred to as dictionaries.) To represent a directed graph, this disclosure defines each key as a single, unique letter occurring in the word under consideration, while the value (to the right of the colon) is a set of letters (also occurring in the word) which follow the key word. Thus, e.g., the key/value pair ‘a’: {‘t’,′l′,′b′} would indicate that in the word under consideration, the letters ‘t’, ‘l’, and ‘b’ follow the letter ‘a’ somewhere in the word. All the letters of the root word are first processed in this way. Then the letters of the subwords are added to the value portion of the pairs to indicate that in the subwords these additional letters follow the letters of the root word. (Recall that each letter of each subword occurs in the root word by definition.) The key/value dictionary is first initialized using each of the letters as keys and with value sets that are initially empty. The value sets are recursively built up by passing through each letter of the root word and each letter of the subwords.

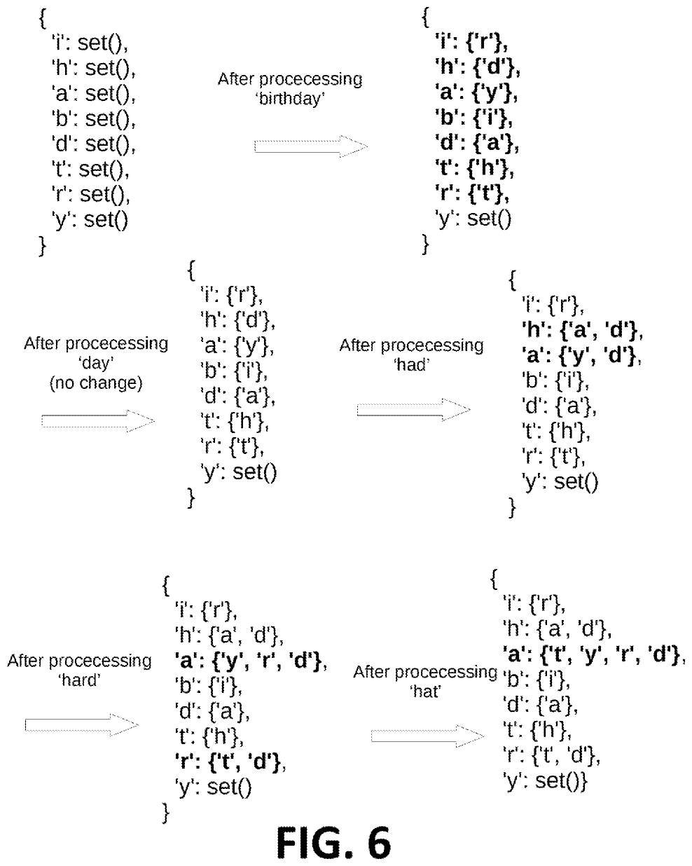

FIG. 6 illustrates a detailed example of how the word “birthday” is processed and how the key/value dictionary changes state with the processing of each subword. In FIG. 5 the key/value dictionary representation is presented abstractly. In FIG. 6, the root word ‘birthday’ is processed and then each of the subwords ‘day’, ‘had’, ‘hard’ and ‘hat’ are processed in turn. The end result of this processing is the in-memory representation of the word ‘birthday’ and its subwords as a single directed graph; the representation is in the form of a key/value dictionary.

FIG. 7 shows a .DOT file representation of a portion of the graph for the root word ‘birthday’ and its subwords ‘day’, ‘had’, ‘hard’ and ‘hat’. This file is the result of transforming the in-memory representation in key/value form into a textual representation in the graphviz language. This file is processed by the open-source dot command to produce the graphics file representation. E.g., if the DOT filename is ‘birthday.dot’, the Linux command ‘d-ot-Tjpg birthday.dot-o birthday.jpg’ would result in a JPEG file, birthday.jpg, being produced that depicts the graph visually for the end user. Since all the nodes are labeled with their associated letters, the resulting graph would be identical to that presented in FIG. 2, the solved puzzle for ‘birthday’ and the subwords ‘day’, ‘had’, ‘hard’ and ‘hat.’.

Details of alternative embodiments may be included in the provisional application's attached appendix which is included by reference as if fully set forth herein.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and, in a manner, consistent with the scope of the invention, as set forth in the following claims.

What is claimed:

1. A puzzle, said puzzle including:
a plurality of placeholder indicia;
a plurality of relationship indicia, said relationship indicia disposed to associate at least a first placeholder of the one or more of the placeholder indicia with a second placeholder of the one or more placeholder indicia,
wherein the association of the first placeholder and the second placeholder indicates a portion of a word spelled with at least a first letter and a second letter.

2. The puzzle of claim 1 wherein said associations include multiple words.

3. The puzzle of claim 1 wherein one or more placeholder indicia include a letter.

4. The puzzle of claim wherein the plurality of relationship indicia includes an arrow.

5. The puzzle of claim 1 wherein the association of the first placeholder and the second placeholder indicates a subword.

6. A method of making a puzzle including the steps of:
identifying a first word in a language, said word including a plurality of letters;
identifying one or more subwords of the first word;
associating the letters of the first word and subwords, said associating including the ordering of letters in the first word and subwords;
presenting an indicia of the puzzle, said indicia of the puzzle including a placeholder indicia for each letter in the first word and a connecting indicia representative of the order of letters in the first word;

7. The method of claim 6 wherein the placeholder indicia is one of either an oval, a line or a rectangle.

8. The method of claim 6 wherein the connecting indicia is one of either a line or an arrow.

9. The method of claim 6 wherein at least one of the placeholder indicia for each letter includes a letter;

10. The method of claim 6 wherein the connecting indicia is also representative of the subwords.

11. One or more processor-readable memory devices, said devices including non-transient, machine readable, instructions directing the processor to perform a method including:
identifying a first word in a language, said word including a plurality of letters;
identifying one or more subwords of the first word;
associating the letters of the first word and subwords, said associating including the ordering of letters in the first word and subwords;
presenting an indicia of the puzzle, said indicia of the puzzle including a placeholder indicia for each letter in the first word and a connecting indicia representative of the order of letters in the first word;

12. The method of claim 11 wherein the placeholder indicia is one of either an oval, a line or a rectangle.

13. The method of claim 11 wherein the connecting indicia is one of either a line or an arrow.

14. The method of claim 11 wherein at least one of the placeholder indicia for each letter includes a letter;

15. The method of claim 11 wherein the connecting indicia is also representative of the subwords.
